(19) United States
(12) Patent Application Publication
(10) Pub. No.: US 2014/0356511 A1
(43) Pub. Date: Dec. 4, 2014

(54) COFFEE LIQUEUR COMPOSITIONS

(71) Applicant: Richardo's, LLC, Lyons, CO (US)

(72) Inventor: Richard A. England, Lyons, CO (US)

(21) Appl. No.: 14/293,987

(22) Filed: Jun. 2, 2014

Related U.S. Application Data
(60) Provisional application No. 61/830,881, filed on Jun. 4, 2013.

(51) Int. Cl. C12G 3/06

(52) U.S. Cl. CPC C12G 3/06
USPC 426/592; 426/594

(57) ABSTRACT

The present invention relates to novel coffee liqueurs, and methods of producing the same. Coffee liqueurs described herein have unique utility and taste profiles that distinguish them from other conventional coffee based drinks

### TECHNICAL FIELD

The present invention relates to a novel coffee liqueur, and methods of producing the same.

### BACKGROUND OF THE INVENTION

Alcoholic liqueurs are popular beverages for consumption alone or in combination with other ingredients in mixed beverages or cocktails, and generally contain one or more flavors that improve the palatability of beverages containing a relatively high content of alcohol by volume. Liqueurs manufactured using coffee or flavored with coffee are popular in mixed beverages, and are widely consumed. Alcoholic liqueurs and mixed beverages are generally consumed in the afternoon, evening, or night. For example, a cocktail using vodka, coffee liqueur, and cream is a popular after-dinner drink. Due to the ingredients and production processes used, these coffee liqueurs contain varying amounts of caffeine. Caffeine is tolerated differently for each individual. For most individuals, ingestion of caffeine promotes mild alertness and decreases tiredness. For others, it is poorly tolerated and may cause nausea or other unwanted effects. Even small amounts of caffeine consumed late in the day may prevent sleep onset or the ability for an individual to obtain restful sleep. Additionally, the manufacture of alcoholic liqueurs from commercially-available spirits presents a tradeoff between alcohol by volume and desired viscosity, and the methods employed to create alcoholic liqueurs may require specialized equipment and increase the overall cost of the commercial product. Finally, conventional bottling methods may also contribute to the oxygen degradation of the flavorants added to liqueurs, causing their flavor profile to change over time.

The present invention is directed toward overcoming one or more of the problems discussed above.

### BRIEF DESCRIPTION OF THE DRAWINGS

FIG. 1 is a flow chart of coffee liqueur production and distribution in accordance with one embodiment of the present invention.

FIG. 2 is a schematic diagram showing the basic process involved with brewing, storing and bottling coffee liqueur embodiments in accordance with the present invention.

### SUMMARY OF THE INVENTION

Embodiments herein provide coffee liqueur compositions (coffee liqueur herein) and methods of preparing the same.

A high quality coffee liqueur is provided having limited to trace amounts of caffeine, high-proof grain alcohol, vanilla extract and sugar. The coffee taste is attributed to the use of instant decaffeinated coffee or low caffeine coffee beans, the high-proof grain alcohol is typically at least 95.8% alcohol by volume, the vanilla extract is typically from a Mexican bourbon vanilla cultivar and the sugar is typically sucrose. Viscosity and taste of the coffee liqueur are modified by production methods, aging and use of particular non-conventional ingredients for coffee liqueurs.

Coffee liqueur production methods are also provided herein for maximizing taste and minimizing product taste degradation, including timing of product release from production and anti-oxidative steps after the coffee liqueur has been prepared.

These and other aspects of the invention are described in more detail below.

### DESCRIPTION

Commercially available coffee liqueurs are manufactured using a variety of base alcohols and coffees, and contain caffeine. For example, a popular and widely-available coffee liqueur contains approximately 4.85 mg of caffeine per 1.5 fl oz. serving. Typical drinks may include multiple servings, and typical cocktail drinkers may have many servings in a continuous time period. Liqueurs may also be used on or in desserts. Liqueurs are typically ingested in the afternoon, evening, or at night, resulting in significant caffeine consumption at these times.

There is a broad range in individual sensitivity to caffeine. Studies have shown that there is an identifiable genetic component to self-identified “caffeine-sensitive” individuals, who report that they voluntarily reduce their caffeine consumption to prevent sleep impairment (Rétey et al., A genetic variation in the adenosine A2A Receptor gene (ADORA2A) contributes to individual sensitivity to caffeine effects on sleep. Clinical Pharmacology & Therapeutics 2007;81:692-8). For example, research comparing individuals with caffeine-induced wakefulness to those not as affected by caffeine indicates that the former have considerably longer plasma caffeine half-lives, resulting in a higher likelihood of insomnia even eight hours after drinking coffee (Levy et al., Caffeine metabolism and coffee-attributed sleep disturbances. Clinical Pharmacology and Therapeutics 1983;33:770-5). Additionally, individuals with anxiety disorders have also been found to be caffeine-sensitive, with the consumption of one cup of coffee often triggering panic and anxiety (Boulenger et al., Increased sensitivity to caffeine in patients with panic disorders: preliminary evidence. Archives of General Psychiatry 1984;41(11):1067-71).

Alcohol, in amounts commonly consumed, is a strong inhibitor of caffeine metabolism (George et al., Influence of alcohol and caffeine consumption on caffeine elimination. Clinical and Experimental Pharmacology and Physiology 1986;13(10):731-6). Alcohol ingested with coffee is therefore likely to decrease caffeine metabolism, resulting in a prolonged, elevated caffeine blood plasma concentration. The synergistic effects of alcohol and caffeine in promoting wakefulness negatively impact sleep amount and quality, especially in sensitive individuals that already have either a longer caffeine elimination time or a stronger physiological reaction to low amounts of caffeine. The synergistic effects of the caffeine and alcohol provided by coffee liqueurs results in an increased likelihood of unwanted wakefulness or the onset of other symptoms associated with caffeine sensitivity, and may prevent caffeine-sensitive individuals from enjoying coffee liqueurs.

A number of caffeinated alcoholic drinks have received negative publicity after news agencies reported several incidents of serious injury, drunken driving, assault, and other dangerous behavior that occurred after drinking caffeinated alcoholic beverages (Harris, F. D. A. says it may ban alcoholic drinks with caffeine. New York Times, New York Edition Nov. 13, 2009, page A11). In 2010, the combined consumption of caffeine and alcohol was declared a “public health concern” by the U.S. Food and Drug Administration, which stated that the addition of caffeine to certain alcoholic beverages could not be generally recognized as safe (CNN Wire Staff, FDA calls 7 caffeine-alcohol drinks unsafe, CNN Nov. 17, 2010). Some states and cities have gone as far as to ban caffeinated energy drinks as a class. The negative health consequences of combining caffeine and alcohol are known to the general public, however coffee liqueurs continue to contain varying amounts of caffeine.

Additional related considerations in the formulation of a coffee liqueur are the base liquor and beverage viscosity. Liqueurs are generally made from the combination of a commercially-available, neutrally-flavored distilled spirit with sweeteners and flavors or flavor extracts, the relative amounts of which determine viscosity and alcohol by volume. The ethanol, water, and other compounds in the base liquor tend to reduce the viscosity of any liqueur. The use of typical liquors, such as vodka in the 80-100 proof range, results in the beverage manufacturer having to choose between reducing the alcohol by volume to achieve a thicker viscosity, and adding thickeners that may change the flavor profile of the beverage. The flavor profile of a coffee liqueur is critical to its enjoyment and commercial viability, and the choice of base liquor largely determines the flavor profile, with commercially-available spirits limiting other aspects of the formulation of a desirable beverage.

Alcoholic liqueurs are manufactured using a variety of methods. Ingredients may be combined before a cooking or brewing step, and fermented together and distilled into a final product. Alternatively, commercially-available or other liquors may be used in combination with additive ingredients, and mixed with or without a heating step. The method employed determines flavor, viscosity, consistency, and the amount of separation observed in the final beverage, and impacts the final price. Generally, the manufacture of flavored liqueurs requires complex equipment and methods, increasing the commercial price.

Commercially-available coffee liqueurs frequently include secondary flavors, such as spices, that modify the taste and smell of the beverage. The secondary flavors may be added before or after, and may be in the form of an extract. The specific origin of the flavorings, timing of their inclusion, and method of manufacturing the beverage determine the extent to which the resulting liqueur incorporates their flavors and aroma, and may also modify the viscosity of the product. One spice that may be included is vanilla, which is preferred for its floral overtones and sweet flavor that compliments and improves the flavor of coffee. The three most commonly available vanilla cultivars are Tahitian, Mexican, and Bourbon/Madagascar vanilla, with each having a distinct flavor profile (Types of vanilla: Tahitian, Mexican and Madagascar. Huffington Post, Apr. 9, 2012, accessed online Mar. 26, 2013). Conventional coffee liqueurs may use extracts of multiple cultivars, or may include imitation vanilla, which may result in suboptimal flavor or even include coumarin, which is moderately hepatotoxic to humans if consumed in high doses (Marles et al., Coumarin in vanilla extracts: Its detection and significance. Economic Botany 1987;41:41-7; abstract only).

The inclusion of secondary flavors, including spices, may decrease the shelf life of the liqueur. While alcohol has a substantial shelf life over which it will maintain the same flavor profile, coffee has a much shorter shelf life. Spice extracts, such as vanilla, may have substantial edible shelf lives; however their flavor profile changes over time as oxygen and other compounds react with the extract compounds. A typical bottle for a liqueur includes a screw-top or corked closure, which is permeable to oxygen. As the compounds of the liqueur react with oxygen, additional oxygen is allowed to enter the bottle, allowing a continual degradation of the product.

The present invention overcomes these problems by using a decaffeinated instant coffee to reduce the amount of caffeine. Additional improvements are the use of a high-proof alcohol, a simplified process for manufacturing a coffee liqueur, the optional inclusion of a Mexican bourbon vanilla extract, and the optional use of a hand-resealable flip-top bottle.

The present invention comprises a liqueur made with decaffeinated coffee. Coffee, as used herein, refers to any harvested and prepared bean, or any combination of harvested and prepared beans, of the genus Coffea, including but not limited to Arabica and Robusta varieties. Decaffeinated, as used herein, refers to coffee with a low caffeine content compared to regular coffee, optimally with less than 50 mg per 8 fl. Oz. prepared cup. In some embodiments, the caffeine content is less than 40 mg per 8 fl. Oz. prepared cup, less than 30 mg per 8 fl. Oz. prepared cup, less than 20 mg per 8 fl. Oz. prepared cup, or less than 10 mg per 8 fl. Oz. prepared cup. In additional embodiments, there are only trace amounts or undetectable amounts of caffeine or caffeine may be entirely absent. The coffee may be decaffeinated using any method, e.g. using water, ethyl-acetate, supercritical carbon dioxide, liquid carbon dioxide, or methylene chloride (Decaffeination. International Coffee Organization [http://www.ico.org/decaffeination.asp], accessed Mar. 26, 2013). The invention may also use a low caffeine coffee bean cultivar, such as Coffea charrieriana, or a genetically modified coffee bean that produces lower caffeine concentrations.

The coffee is preferably instant coffee, which may be prepared by any commercial method, such as freeze-drying or spray drying. Additional forms of instant coffee suitable for use in the invention include liquid preparations or other concentrates. Instant coffee is advantageous because it is essentially dried prepared coffee, and upon rehydration does not contain substantial bean fragments or coffee grounds, which impair flavor and texture. Instant coffee has the further advantage of absorbing significant amounts of water within the mixture, while non-instant prepared coffee contains additional water, making it more difficult to achieve the desired beverage viscosity without the addition of adjunct materials or additional steps to evaporate or otherwise reduce water content. Also, because the instant coffee is designed to have desirable and consistent flavor and texture profiles after dehydration and rehydration, the final product can be made with greater consistency as compared to the use of non-instant coffee. Flavor and texture consistency between individual units of a product are critical to establishing brand value and retaining customers, who rely on consistent flavor when enjoying the product alone or in combination with other ingredients in a cocktail or mixed drink.

The liqueur comprises a base alcohol, which is one or more distillates of one or more fermented products. The fermented products are of any type normally fermented to produce alcohol for human consumption (ethanol), including but not limited to grain, potato, corn, sugar or sugar cane, or any other source of fermentable sugars/carbohydrates. The products are fermented using any technique to obtain a liquor having a relatively low alcohol by volume, and are then distilled using any technique to increase the alcohol by volume. The base alcohol may be varied depending on the desired flavor, alcohol by volume, and viscosity of the final product. In some embodiments, the alcohol by volume is relatively high, and is preferably higher than that of common commercially available liquors, which generally contain 30-50% alcohol by volume. A typical base alcohol of the invention is a high-proof alcohol, containing an alcohol by volume of around 95.8%. More typically, the base alcohol is a high-proof alcohol derived from grain.

High-proof alcohol is preferred because it contains fewer non-ethanol compounds, which modify the final flavor of the product. High-proof grain alcohol is a neutral flavored spirit that imparts no undesirable flavors to the liqueur, and is unlikely to vary in flavor between distillations. Also, because the flavors of most alcohols vary between distillation batches, the use of high-proof alcohol allows the substitution or mixing of high-proof alcohols derived from different base materials with little impact on flavor. Further, the use of high-proof alcohol reduces the amount of water added with the alcohol, reducing the need for additional calculation in the manufacture of the liqueur.

The liqueur may further comprise one or more sugars or other sweeteners to improve the taste of the product. The sugar may be selected from any sugar for human consumption, and in one embodiment is sucrose. In other embodiments, the sugar is fructose, dextrose, corn syrup, or a combination of sugars suitable for human consumption. The inclusion of sugar also thickens the liqueur, allowing the manufacturer to achieve a desired viscosity.

The liqueur may further comprise water, which may be of any suitable type, including but not limited to water containing additional chemicals or substances, such as spring or tap water, or substantially pure water, such as distilled water. In a preferred embodiment, distilled water is used. The use of distilled water improves batch consistency by eliminating the effects of the variable inclusions found in tap or spring water, and also allows a favored water profile to be created using additional minerals and additives if required. In another embodiment, spring water or treated river water is used, and may be adjusted to a preferred mineral profile by adding compounds or adjusting pH. The amount of water may be varied to adjust the viscosity and other characteristics of the final product.

The coffee liqueur of the invention optionally comprises further additives that enhance one or more features of the liqueur, such as taste, texture, aroma, or stability. The additives may include natural or artificial chemicals, including but not limited to plant extracts, spices, and artificial flavorings. An exemplary additive is a vanilla extract. Vanilla extract is preferred for its flavor, as well as its improved consistency over the addition of non-extract vanilla, which has a greater variation in flavor and potency between individual pods and commercial batches. Vanilla extract also has as greater shelf life, and may give an increased shelf life to the final product as compared to using non-extract vanilla. Also, the use of vanilla extract eliminates the need to filter and remove vanilla bean particles, making the production of the liqueur more efficient.

In a typical embodiment, the vanilla extract is from a Mexican bourbon vanilla cultivar. Mexican bourbon vanilla is prized for its strong vanilla flavor and subtle underlying sweetness, and provides a substantially stronger flavor than regular Mexican vanilla because it is derived from a Madagascar vanilla cultivar.

The liqueur of the invention may be manufactured by any number of methods, and the ingredients can be added in different orders and at different times, depending on the desired product characteristics. A preferred method of the invention is to prepare a mixture of instant decaffeinated coffee, base liquor, water, and optional additives such as sugar and vanilla extract, and mix at a temperature suitable to dissolve the sugar. The mixture is optionally adjusted or diluted with water as desired, is optionally filtered, and is bottled into a commercially-appropriate container. The container is preferably of a hand resealable flip-top design, which allows a consumer to easily reseal the bottle between uses. This may increase the shelf life of the product by limiting the amount of oxygen available to oxidize compounds in the liqueur. The liqueur may optionally be aged before being bottled or after bottling but before being sold commercially to improve the flavor profile, viscosity, consistency, or aroma.

In a preferred embodiment, the manufacturing procedure includes the following steps: dissolving the coffee into water, dissolving the sugar into the water/coffee mixture, optionally adding vanilla, adding ethanol, mixing thoroughly, adjusting to the desired volume using water, then bottling the resulting product. The mixture is optionally aged for at least 15 to 30 days before or after bottling, typically at least 20 days before or after bottling, more typically at least 30 days before or after bottling.

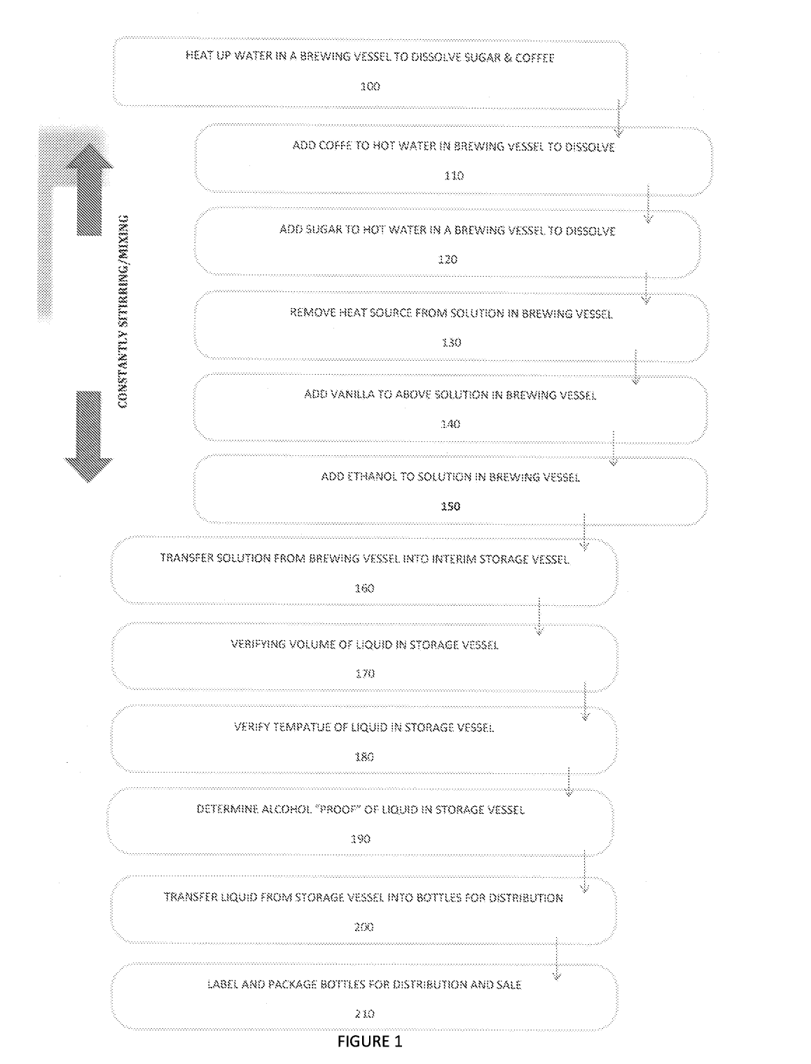

Referring to the Figures, FIG. 1 illustrates one possible production, storage and bottling embodiment in accordance with the present invention. Initially an amount of water is obtained and heated in a brewing vessel 100. The amount of water is determined by the ultimate batch size of desired end-product but can be 1 gallon, 5 gallons, 10 gallons, 20 gallons or other increment. Typical embodiments allow the water to reach and maintain a temperature of from 125° F. to 150° F. The water can be obtained from a spring or tap source, can be distilled, deionized, or distilled and deionized. Heated water is stirred/mixed constantly during the production phase, i.e., prior to transfer into storage vessels or distribution bottles.

Decaffeinated coffee is added to the heated water 110. The heated water is stirred until substantially all of the coffee is dissolved. Decaffeinated coffee can be brewed and added to the water as a liquid, in which case 1.5-2.5 ounces of brewed decaffeinated coffee is added per one gallon of pre-heated water. In the absence of pre-brewing the decaffeinated coffee, the ground bean can also be added directly to the heated water.

Sugar is also added to the heated water 120. The sugar can be added prior to, with or after addition of the decaffeinated coffee. The sugar/heated water is stirred until substantially all of the sugar is dissolved. In one embodiment, from 2.5 to 3.0 pounds of sugar is added per gallon of water.

After both the coffee and sugar are in solution the brewing vessel is removed from the heat source 130. The solution is allowed to cool back to room temperature and from 50 to 60 milliliters of vanilla extract is added per gallon of water 140. Prior to, with or after addition of the vanilla to the cooled solution, 1 to 1.5 pounds 191.6 proof (95.8% ABV) ethanol is added per gallon of solution 150.

Once the vanilla and ethanol are fully incorporated, the solution is removed from mixing/stirring conditions and the solution transferred from the brewing vessel to an interim storage vessel 160. Interim storage vessels include large sealed vessels, for example stainless steel vessels (one particular embodiment is a 55 gallon stainless steel sealed vessel. The liquid volume of the solution can be verified in these vessels 170. The solution temperature can also be verified.

Based on the liquid volume and amount of ethanol added to the solution a “proof” of liquid is determined 190. In some embodiments, the coffee liqueur is now ready to be aged for from 15 to 30 or more days in the storage vessel and more typically from 20 to 30 or more days in the storage vessel. In some embodiments the coffee liqueur is aged for at least 30 days. It is also envisioned that coffee liqueurs of the invention can be transferred to bottles for distribution prior to being aged. Regardless, the aged or non-aged coffee liqueur is transferred to bottles for distribution 200. Where the liqueur was not aged in the storage vessel, the liqueur could be aged in the bottle for an amount of time previously discussed herein. Finally, bottled liqueur is labeled and packaged for distribution and sale 210. As noted above, typical embodiments herein utilize resealable flip-tip bottles that limit product oxidation. Although not shown in FIG. 1, the coffee liqueur can also be filtered between transfer of the solution from the brewing vessel to the storage vessel or between transfer between the storage vessel and the distribution bottles. Typical filters can be built into a transfer funnel and are appropriate for debris removal.

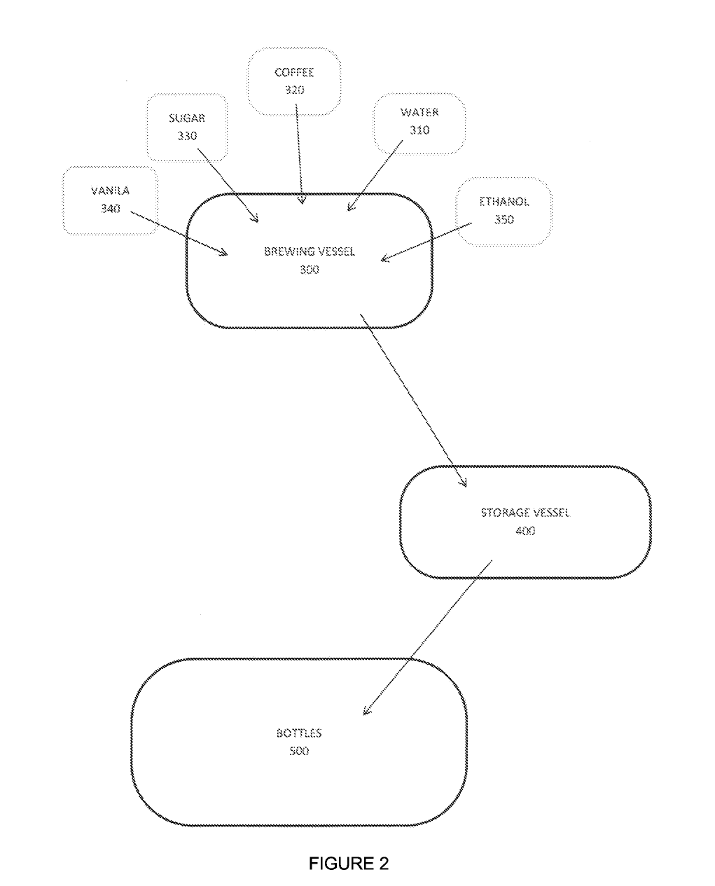

Referring to FIG. 2, a simplified schematic shows addition of vanilla, sugar, coffee, water and ethanol to a brewing vessel 300. Storage of the solution is storage vessels 400 and transfer of the solution to bottles for distribution and sale of the liqueur.

The batch size, or amount produced at any given time, may be any suitable volume, depending on the desired output. The product characteristics generally do not vary considerably with increased batch size, and the relative ingredient amounts may be held constant as batch size increases, or varied by small amounts to achieve the desired product characteristics. In some embodiments, the contributions of certain additives to one or more features of the liqueur may not scale in a linear fashion with the amount added, requiring the relative amount of the additive or additives to be increased or decreased as the remaining ingredients are scaled in a linear fashion. The equipment used in production may change as batch size increases. For example, as batch size increases, larger mixing and storage vessels or larger scale commercial mixing or preparation equipment may be used. In a typical embodiment, a batch size of 10 gallons is used. In additional embodiments, the batch size may be less than 10 gallons, greater than 10 gallons but less than 50 gallons, greater than 50 gallons but less than 500 gallons, or greater than 500 gallons.

The final texture and viscosity of the product may vary depending on the intended use or commercial variation of the product. For example, the desired viscosity for use in a beverage may be less than the desired viscosity for use as a dessert topping, for which a thicker consistency is preferred for retention on the surface of the dessert. The viscosity may be adjusted by any available method, such as by changing the relative amounts of any of the ingredients, adjusting the alcohol-by-volume of the base alcohol, or adjusting the concentration of any included extract. In one embodiment, the use of high-proof grain alcohol allows a higher maximum viscosity to be achieved at a desired product alcohol-by-volume.

Preferred ingredient amounts for a 10 gallon batch size are shown in Table 1.

TABLE 1

| Ingredient | Amount | |
|---|---|---|
| Water | 40-45 | lbs. |
| Vanilla Extract | 500-600 | mL |
| Instant Decaf Coffee | 15-25 | oz. |
| Sugar | 25-30 | lbs. |
| Ethanol (191.6 proof, 95.8% ABV) | 10-15 | lbs. |

### EXAMPLES

The following examples are provided for illustrative purposes only and are not intended to limit the scope of the invention.

### Example 1

10 gallons of liqueur was made using the components and amounts in Table 2. A 10 gallon batch size was selected.

TABLE 2

| Ingredient | Amount | |
|---|---|---|
| Water | 46.12 | lbs. |
| Vanilla Extract | 591.5 | ml |
| Instant Decaf Coffee | 20 | oz. |
| Sugar | 29 | lbs. |
| Ethanol (191.6 proof, 95.8% ABV) | 14.14 | lbs. |

First, the coffee is dissolved into the water. Next, the sugar is dissolved into the water/coffee mixture. The vanilla is added, followed by the ethanol. The mixture is mixed thoroughly, then additional water is added to adjust the mixture to approximately 10 gallons. The resulting mixture is bottled into resealable brown glass flip-top bottles and stored in a dark location for a minimum of 30 days.

While this invention has been described with an emphasis upon typical embodiments, it will be understood by those of ordinary skill in the art that variations of the typical embodiments may be used and that it is intended that the invention may be practiced otherwise than as specifically described herein. Accordingly, this invention includes all modifications encompassed within the spirit and scope of the invention as defined by the following claims.

What is claimed is:

1. A decaffeinated coffee liqueur.

2. The decaffeinated coffee liqueur of claim 1, comprising high-proof grain alcohol and decaffeinated coffee.

3. The decaffeinated coffee liqueur of claim 2, wherein said decaffeinated coffee is an instant coffee.

4. The decaffeinated coffee liqueur of claim 2, further comprising a vanilla extract.

5. The composition of claim 4, wherein the vanilla extract is a Mexican bourbon vanilla extract.

6. A method of making a coffee liqueur, the method comprising combining and mixing an alcohol, water, decaffeinated instant coffee, and a sugar.

7. The method of claim 6 further comprising adding vanilla extract.

8. The method of claim 6 wherein the vanilla extract is a Mexican bourbon vanilla extract.

9. The method of claim 6 wherein the alcohol is high-proof grain alcohol.

10. The method of claim 6 wherein the coffee liqueur is filtered and placed in a hand re-sealable bottle.

11. The method of claim 10 wherein the coffee liqueur is filtered and placed in a sealed stainless steel vessel for aging prior to transfer to hand re-sealable bottles.

12. The method of claims 6 wherein the method is performed at room temperature.

13. The method of claim 11 wherein the coffee liqueur is aged for at least 15 days.

14. The method of claim 11 wherein the coffee liqueur is aged for at least 30 days.
